(19) United States
(12) Patent Application Publication
(10) Pub. No.: US 2026/0088702 A1
(43) Pub. Date: Mar. 26, 2026

(54) AUTO-BALANCED MULTI-CHANNEL POWER SUPPLY

(71) Applicant: UBICQUIA, INC., FORT LAUDERDALE, FL (US)

(72) Inventor: Wei Xiong, Madison, AL (US)

(21) Appl. No.: 19/336,145

(22) Filed: Sep. 22, 2025

Related U.S. Application Data
(60) Provisional application No. 63/697,582, filed on Sep. 22, 2024.

(51) Int. Cl. H02M 1/00; H02M 7/217

(52) U.S. Cl. CPC H02M 1/0067; H02M 7/217

(57) ABSTRACT

A multi-channel power supply includes a switching circuit and at least two channel circuits. The switching circuit includes a switching controller and a transformer having a primary winding and multiple secondary windings. The switching circuit converts power received at the primary winding into powers output by the secondary windings responsive to a first control signal received by the switching controller. Each channel circuit is coupled to a respective secondary winding of the transformer. The first channel circuit includes a feedback regulation circuit and a controlled/controllable load. The feedback regulation circuit provides the first control signal responsive to electrical loading applied to the first channel circuit's output. The controlled load applies at least a minimum load to the first channel circuit's output responsive to receipt of a second control signal. The second channel circuit outputs the second control signal when a load is applied to the second channel circuit's output.

### CROSS-REFERENCE TO RELATED APPLICATIONS

The present application claims the benefit of and priority upon U.S. Provisional Patent Application No. 63/697,582, which was filed on Sep. 22, 2024, and is incorporated herein by this reference as if fully set forth herein.

### TECHNICAL FIELD

The present disclosure relates generally to multi-channel power supplies, and, more particularly, relates to a multi-channel power supply that balances the auxiliary channels with the main channel to prevent voltage sag on the auxiliary channels during light load periods at the main channel.

### BACKGROUND

In a multi-channel or multi-output power supply, there is typically a control circuit on the primary side, and a main channel on the secondary side. The main channel provides power to a main circuit or circuitry and provides a feedback signal to the control circuit on the primary side. When the load at the main channel increases, the control circuit causes more energy transfer to the secondary side to ensure that the voltage level remains at or above a given threshold. The control circuit is typically a switching circuit, such as a flyback circuit. Pulses are provided by a controller to a switch sub-circuit to cause the desired switching, which transfers power to the secondary side and to the main channel. When the load at the main channel is light (reduced), the control circuit can skip pulses. Sometimes several pulses in a row may be skipped to reduce the duty cycle of the switching operation. While this operation works well for the main channel, it can be a problem for auxiliary channels on the secondary side of the power supply.

An auxiliary channel or output is typically formed by an addition independent winding. The rectification and capacitive filtering, along with the auxiliary winding size, at the auxiliary channel are designed to provide a desired output level assuming a nominal load at the main channel. There is no control feedback from the auxiliary circuit to the control circuit on the primary side of the power supply in order to avoid conflicting feedback and/or a race condition. As such, the auxiliary channel is passive and dependent on the main channel regulation to maintain the desired auxiliary output level.

A problem occurs, however, when the load at the main channel is reduced to a load lower than the nominal load. When this occurs, as mentioned above, pulse skipping is commonly employed by the control circuit on the primary side to prevent over-charging the bulk capacitance on the main channel's rectification and filtering circuit. However, while the load on the main channel may be reduced below the nominal load level, the load on the auxiliary channel(s) may not be reduced, and as a result of the pulse skipping, the output level at the auxiliary channel can drop below a minimum threshold needed to ensure proper operation of the auxiliary circuity.

### SUMMARY

In accordance with some embodiments of the present disclosure, a multi-channel power supply includes a switching circuit and at least two channel circuits. The switching circuit includes a switching controller and a transformer having a primary winding and multiple secondary windings. The switching circuit converts electrical power received at an input to the primary winding of the transformer into electrical powers at outputs of the secondary windings of the transformer responsive to a first control signal received by the switching controller. Each channel circuit is coupled to an output of a respective secondary winding of the transformer. The first channel circuit includes a feedback regulation circuit and a controlled/controllable load. The feedback regulation circuit provides the first control signal responsive to electrical loading applied to the output of the first channel circuit. The controlled load applies at least a minimum electrical load to the first channel circuit's output responsive to receipt of a second control signal. The second channel circuit outputs the second control signal when an electrical load is applied to an output of the second channel circuit.

In the above embodiments and others, the first channel circuit and the second channel circuit may share a common ground. In such embodiments, the second channel circuit outputs the second control signal directly to the controlled load. In other embodiments, the first channel circuit and the second channel circuit may not share a common ground. In these embodiments, the power supply may further comprise an optocoupler or opto-isolator positioned between the first channel circuit and the second channel circuit. The second channel circuit outputs the second control signal to the controlled load through the optocoupler.

According to further embodiments, the controlled load includes a load resistance in series with a load transistor. In such embodiments, a control terminal of the load transistor is configured to receive the second control signal from the second channel circuit.

According to some other embodiments, a multi-channel power supply operable to supply electrical power to multiple electrical loads includes a switching circuit and at least three channel circuits. The switching circuit converts electrical power received at an input to the primary winding of the transformer into electrical powers at outputs of the secondary windings of the transformer responsive to a first control signal received by the switching controller. Each channel circuit is coupled to an output of a respective secondary winding of the transformer. The first channel circuit includes a feedback regulation circuit and a controlled/controllable load. The feedback regulation circuit provides the first control signal responsive to electrical loading applied to the output of the first channel circuit. The controlled load applies at least a minimum electrical load to the output of the first channel circuit responsive to receipt of at least one of a second control signal and a third control signal. The second channel circuit outputs the second control signal when a first auxiliary electrical load is applied to an output of the second channel circuit. The third channel circuit outputs the third control signal when a second auxiliary electrical load is applied to an output of the third channel circuit. The second and third control signals may be same (e.g., a bias voltage for a transistor of the controlled load) or different depending on configuration of the controlled load.

In the preceding embodiments and others, the first channel circuit, the second channel circuit, and/or the third channel circuit may share a common ground. In such embodiments, the second channel circuit or the third channel circuit, as applicable, outputs the second control signal or the third control signal, respectively, directly to the controlled load. In other embodiments, the first channel circuit, the second channel circuit, and/or the third channel circuit may not share a common ground. In these embodiments, the power supply may further comprise a first optocoupler positioned between the first channel circuit and the second channel circuit and a second optocoupler positioned between the first channel circuit and the third channel circuit. In this case, the second channel circuit outputs the second control signal to the controlled load through the first optocoupler and the third circuit outputs the third control signal to the controlled load through the second optocoupler.

According to further embodiments involving at least three channel circuits, the controlled load includes a load resistance in series with a load transistor. In such embodiments, a control terminal of the load transistor is configured to receive at least one of the second control signal and the third control signal.

According to other embodiments, a multi-channel power supply operable to supply electrical power to multiple electrical loads includes a primary side switching controller, a first channel circuit, a controllable load, and a second channel circuit. The first channel circuit is a secondary circuit which receives power through a secondary winding from a primary winding of a power transformer. The first channel circuit has a regulator feedback circuit that provides a feedback regulation signal to the primary side switching controller. The feedback regulation signal is responsive to a total load on the output of the first channel circuit. Thus, the first channel circuit controls operation of the primary side switching controller via the feedback regulation signal. If the first load requires more power, then the feedback regulation circuit will adjust the feedback regulation signal in response to the change in load to cause the primary side switching controller to provide more power into the power transformer. The controllable load is coupled in parallel with a first or main load of the first channel circuit and is responsive to a load control signal. Thus, the controllable load can be switched on or off or otherwise regulated to some level. The first load and the controllable load together are the total load on the output of the first channel circuit. Thus, changing the controllable load changes the total load on the output of the first channel circuit, which will change the state of the feedback regulation signal as a result. The second channel circuit has an output that is independent of the first channel circuit's output. The second channel circuit includes a voltage comparison circuit that compares the voltage at the output of the second channel circuit with a preselected reference voltage and provides the load control signal to the controllable load when the output voltage of the second channel circuit is lower than the preselected reference voltage. When the output voltage of the second channel circuit is higher than the preselected reference voltage, no load control signal is supplied to the controllable load. Thus, by changing the total load, through the controllable load, at the output of the first channel circuit, the voltage at the output of the first channel circuit will drop and, as a result, the feedback regulation loop control will cause the primary side controller to transfer more power. This means that the second channel circuit is able to cause the primary side controller to increase its power transfer by manipulating the total load on the first channel circuit, resulting in the voltage at the outputs of both the first and second channel circuits to increase.

In accordance with other embodiments of the present disclosure, there is provided a power supply that includes a primary side having a switching controller that is responsive to a feedback regulation signal. The switching controller is configured to adjust a switching operation through a primary winding based on the feedback control signal. The power supply also includes a main channel having a secondary winding circuit including a rectifier and bulk capacitance filter, a main load coupled at an output of the secondary winding circuit, and a controllable load coupled in parallel with the main load at the output of the secondary winding circuit. The controllable load is variable and responsive to a load control signal. The main channel further has a regulator feedback circuit that provides the feedback regulation signal to the primary side, responsive to a total load on the output of the secondary winding circuit. There is also at least one auxiliary channel including an auxiliary winding circuit that is independent of the secondary winding circuit of the main channel and likewise includes an auxiliary rectifier and an auxiliary bulk capacitance filter. There is an auxiliary load at an output of the auxiliary winding circuit. The at least one auxiliary channel does not provide any feedback to the primary side. The auxiliary channel further includes a voltage comparison circuit that compares a voltage at the output of the auxiliary winding circuit with a preselected reference voltage and provides the load control signal to the controllable load such that when the voltage at the output of the of the auxiliary winding circuit drops below the preselected reference voltage the controllable load is turned on thereby increasing a load at the secondary winding circuit to cause the regulator feedback circuit to provide the feedback regulation signal and thereby increase the switching operation of the switching controller.

In accordance with some embodiments of the present disclosure, there is also provided a method of operating a power supply that includes providing, from a main channel to a primary side of the power supply, a feedback regulation signal that corresponds to a load level at an output of the main channel. The feedback regulation signal causes a switching controller at the primary side to adjust a switching operation in correspondence with the feedback regulation signal. There method also includes, at an auxiliary channel that is independent from the main channel, and that provides no feedback to the primary side, providing a load control signal that is based on a comparison of an output of the auxiliary channel with a preselected threshold, to a controllable load at the output of the main channel to cause the feedback regulation signal to adjust the switching operation and thereby maintain the output at the auxiliary channel at or above the preselected threshold.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present disclosure.

FIG. 1 is a prior art schematic diagram of a multi-channel power supply.

FIG. 2A is a graph chart illustrating operation of a prior art multi-channel power supply when the main load is at a nominal level.

FIG. 2B is a graph chart illustrating operation of a prior art multi-channel power supply when the main load is at less than a nominal level, causing the auxiliary channel to drop below a minimum threshold output level.

FIG. 3 is schematic diagram of a load control used by an auxiliary channel power circuit to control the load at the main channel power circuit when the main and auxiliary channel power circuit share a common ground, in accordance with some embodiments of the present disclosure.

FIG. 4 shows a schematic diagram of load control in a power supply system that includes multiple auxiliary channels when the main channel power circuit and auxiliary channel power circuits all share a common ground, in accordance with some embodiments of the present disclosure.

FIG. 5 shows a schematic diagram of load control in a power supply system that includes multiple auxiliary channels when the main channel power circuit and auxiliary channel power circuits do not share a common ground, in accordance with some embodiments of the present disclosure.

FIG. 6 is a graph chart illustrating operation of a multi-channel power supply when the main load is at less than a nominal level, in accordance with some embodiments of the present disclosure.

FIG. 7 shows a block schematic diagram of a lighting control system using a multi-channel power supply in accordance with some embodiments of the present disclosure.

### DETAILED DESCRIPTION

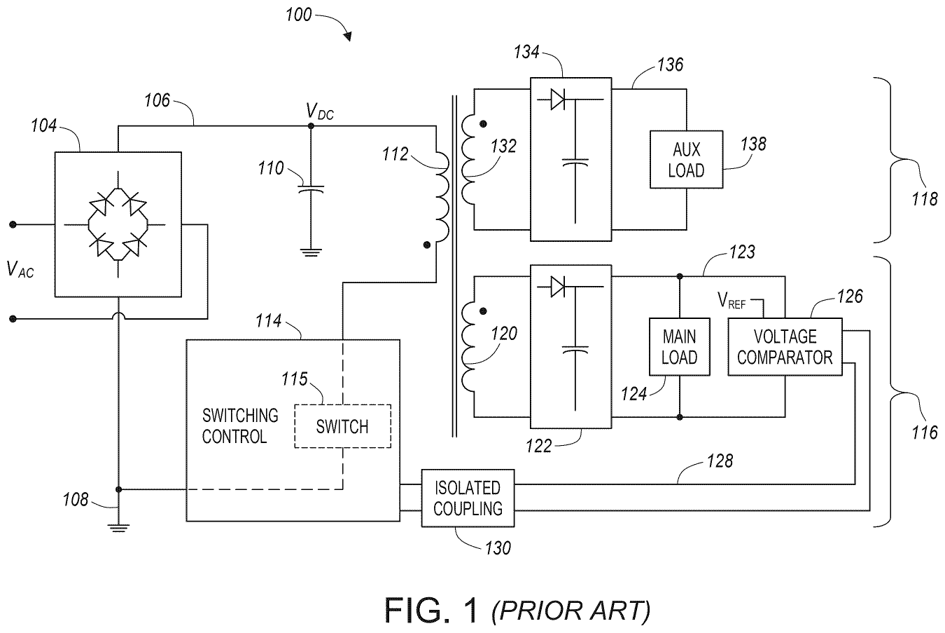

FIG. 1 is a prior art schematic diagram of a multi-channel power supply 100. The disclosed embodiments augment this basic arrangement in order to achieve an improved result where auxiliary channels are not starved when the main channel load is lessened below a nominal load value. In general, an alternating current (AC) source is provided to a bridge rectifier 104 that provides a positive charge to a bulk filter capacitance 110, resulting in a direct current (DC) voltage between line 106 and a DC ground 108. A switching control circuit 114 operates a switch 115 to draw current through a primary winding 112 of a transformer. The switch 115 is controlled by a pulse train generated by the switch control circuit 114 in response to feedback received from the main channel circuit 116, as will be explained. The switching arrangement illustrated here is known as a flyback topology, however the elements can be used with any switching power supply topology. A main channel circuit 116 includes a winding 120 on the transformer that feeds a rectification and filter circuit 122 including a bulk capacitance, as is well known, and provides an output voltage on line 123 to power a load 124. The winding 120 can be described as a secondary winding where winding 112 is a primary winding. As is well known in switching power topologies, current is switched through the primary winding 112 to induce an output at any other winding around the same core that the primary winding 112 is wound around. The main load 124 includes various circuit elements that draw current from the bulk capacitance of the rectification and filter circuit 122. The main load 124 is variable, so demand from the bulk capacitance will likewise vary. To control the output level on line 123, a feedback regulation circuit includes a regulator feedback circuit in the form of a voltage comparison circuit 126 that compares the voltage on line 123 with a reference voltage and provides a feedback regulation signal 128 indicating an error between the reference voltage and the voltage on line 123. Thus, the feedback regulation signal 128 causes the switching controller to adjust its switching operation as the feedback regulation signal varies as a result of the main load or any other load on the main channel output varying. The signal 128 is fed back to the switching control circuit 114 through an isolated coupling 130 to maintain isolation between the primary and secondary sides of the transformer. For example, the isolated coupling 130 can be an opto-coupler or opto-isolator, as is commonly used for power supply control.

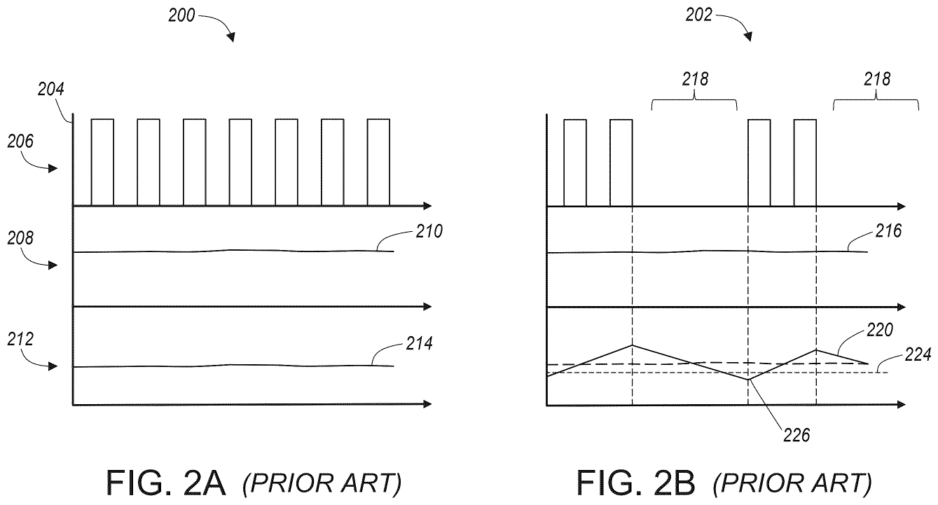

In addition to the main channel circuit, there is an auxiliary channel circuit 118, which includes its own auxiliary winding 132 and rectification and filter circuit 134 to produce an auxiliary output on line 136 to which an auxiliary load 138 is coupled. The rectification and filter circuit 134 includes a diode or auxiliary rectifier to rectify the signal from the auxiliary winding 132 that charges the auxiliary bulk filter capacitance filter to provide a DC voltage level. The auxiliary channel circuit 118 is an additional channel circuit that provides a separate power source to circuitry in the auxiliary load 138 that that separate from the circuitry of the main load 124. Ther can be multiple auxiliary channel circuits, each with its own separate auxiliary load for different and various purposes or functions. The auxiliary channel circuit 118 provides no feedback to the switching control circuit 114, and so the output voltage on line 136 is dependent on the loop control provided by the main channel circuit 116. When the main load 124 is sufficient, the switching operation of the switching control circuit 114 will result in the auxiliary output 136 being sufficient to operate the auxiliary load 138. This situation is illustrated in FIG. 2A. However, when the main load becomes light or low, and requires less power, as a result of the feedback signal 128, the switching control circuit 114 will reduce the amount of switching it does by skipping pulses that control the switch 115. When this happens, the auxiliary channel circuit 118 will also receive less power, and as a result, the voltage level on line 136 provided to the auxiliary load 138 can fall below a minimum threshold that ensure proper operation of the circuitry in the auxiliary load 138. This scenario is exemplified in FIG. 2B. Both the main channel winding 120 and the auxiliary winding 132 are “secondary” windings because power is transferred to them through the transformer via the primary winding 112. Each of the main and auxiliary windings 120, 132 can have, for example, a different number of turns. In some of the following discussion, there can be reference to a first secondary winding and a second secondary winding, for example, which refer to two independent output windings, and the primary winding 112 can be referred to as an input winding.

FIG. 2A is a graph chart 200 illustrating operation of a prior art multi-channel power supply when the main load is at a nominal level. The vertical axis indicates relative magnitude for each several signals. The signals include a pulse train 206 provided by the switch control circuit 114 to the switch 115 when the main load 124 is demanding an ordinary amount of power. As a result, the output voltage 210, as shown on plot 208, of the auxiliary channel circuit is stable and is regulated to the desired level. The auxiliary channel circuit output 214 is shown on plot 212, and because there is ample power being transferred through the auxiliary winding 132, the auxiliary output 214 is sufficient to power the auxiliary load 138. Thus, because the power demand of the main load 124 is sufficiently high, the auxiliary output 214 is likewise sufficient for the auxiliary load 138.

FIG. 2B is a graph chart 202 illustrating operation of a prior art multi-channel power supply when the main load is at less than a nominal level, causing the auxiliary channel to drop below a minimum threshold output level. When the main load 124 has a low power demand, then the switching control circuit will skip pulses, as indicated by skip periods 218 when no pulse is applied to the switch 115. Since the switch is turned on during a pulse, skip periods 218 indicate extended periods when no current is drawn through the primary winding 112. This prevents the output 216 of the main channel circuit from rising above a desired level. However, as be seen in auxiliary output, the auxiliary output level 220 can drop during the skip periods 218 and even fall below a minimum threshold 224 necessary to ensure proper operation of circuity in the auxiliary load 138.

To address this problem, the disclosed auto-balancing multi-channel power supply provides load control on the main channel output when the auxiliary channel output drops below a selected threshold. Each auxiliary channel can impose a load on the main channel output. This load is independent of the main channel circuitry load, and simply acts to discharge the bulk filter capacitor, causing the voltage to at the main channel output to drop. In response, the control feedback of the main channel will automatically cause the primary circuit to increase the amount of switching, and reduce pulse skipping, which will drive up the output at the auxiliary channel(s). Said another way, the auxiliary channel(s), since they do not provide any feedback control to the primary side and operate independently of the main channel, can impose a load (a controllable load) on the main channel to drop the voltage at the main channel output. As a result, the feedback loop will cause the primary side controller to increase switching activity in an attempt to drive the voltage at the output of the main channel up. In doing so, however, because each auxiliary channel has its own independent secondary winding, the output at each of the auxiliary channels will increase as well. Thus, when one auxiliary channel is being starved, it can impose a load on the main channel output to cause the feedback control to cause the primary side to increase switching activity and thereby increase the output at the auxiliary circuit.

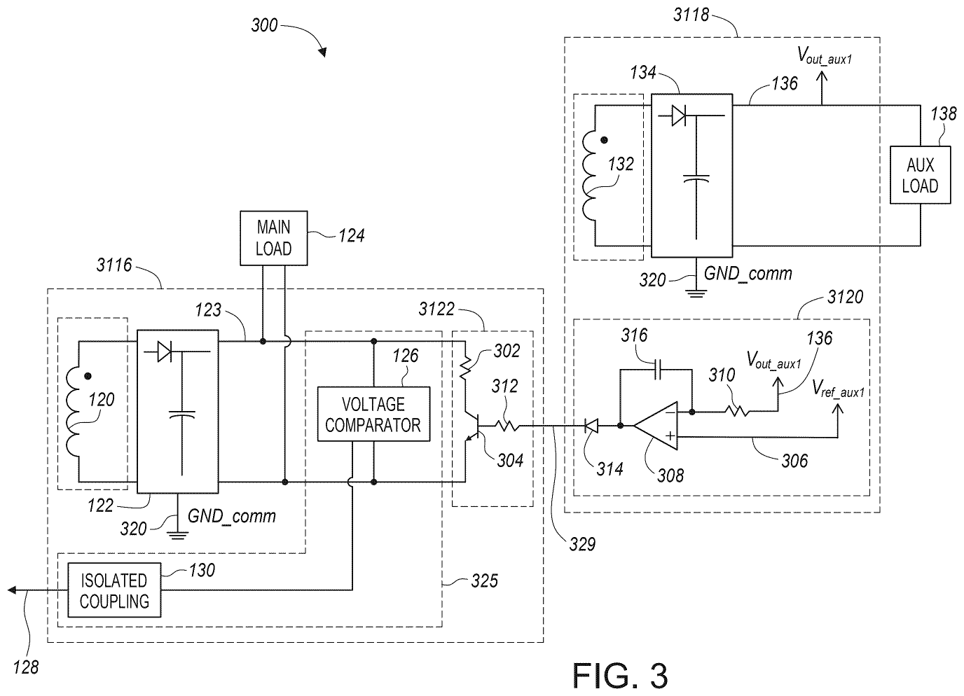

FIG. 3 is schematic diagram of auto-balanced multi-channel power supply 300 including an auxiliary channel circuit 3118 configured to supply power to an auxiliary load 138, as well as produce a control signal 329 to control activation of a controlled load 3122 forming part of the main channel circuit 3116 when the main channel circuit 3116 and the auxiliary channel circuit 3118 share a common ground, in accordance with some embodiments of the present disclosure. Where the main channel circuit 3116 and the auxiliary channel circuit 3118 have re-used components of the prior art, the same reference numerals have been re-used, however each of the main channel circuit 3116 and the auxiliary channel circuit 3118 have been modified in accordance with the present disclosure. Each of the main channel circuit 3116 and the auxiliary channel circuit 3118 receives source energy from a respective independent secondary winding 120, 132 of the switching circuit's transformer, and includes its own rectification and bulk filter circuit 122, 134, respectively.

The main channel circuit 3116 and the auxiliary channel circuit 3118 are shown similar to those of the arrangement of FIG. 1 but modified to allow the auxiliary channel circuit 3118 to impose additional load on the output of the main channel circuit 3116. In this exemplary embodiment, the main channel circuit 3116 and auxiliary channel circuit 3118 share a common ground 320. To impose a load on the output 123 of the main channel, a controllable load 3122, including load resistance 302, is controlled through a transistor 304 and can increase the total load on the main channel output, in addition to the main load 124 (shown for simplicity within the main channel circuit 3116 but such load 124 would be applied to the main channel circuit's output and not form part of the main channel circuit 3116 itself). The resistance of the transistor 304 can vary with the input of a load control signal, from being very high, where it is essentially an open circuit or switch so that there is no conduction through the load resistance 302, to a very low resistance such that the load resistance 302 is effectively coupled in parallel with the main load 124.

To operate the transistor 304 and provide the load control signal, a voltage comparison circuit 3120 of the auxiliary channel circuit 3118 compares a voltage at the output voltage of the auxiliary channel 136 to a reference voltage V_{ref_aux1} which is provided to the non-inverting input 306 of an op amp 308, and is a preselected reference voltage. The auxiliary voltage 136, V_{out_aux1}, is provided through a resistor 310 to the inverting input of the op am 308. The reference volage is selected to correspond to a minimum threshold level of the auxiliary output voltage 136 to avoid a low voltage condition that could cause operating problems with circuitry in the auxiliary load 138. While the auxiliary voltage level is above the reference voltage level, the output of the op amp 308 will remain low, and there will be no conduction through diode 314 and resistance 312 into the transistor 304, maintaining the transistor in a high impedance state, like a switch that is open. When the auxiliary voltage drops below the refence voltage level, the output of the op amp 308 will tend to drive to high, buffered by feedback capacitor 316, and conduction through diode 314 and resistance 312 will occur, reducing the impedance of the transistor 304, and drawing charge from the bulk filter capacitor of the rectification and filter circuit 122, which will tend to reduce the main output voltage on line 123. As a result and referring back to FIG. 1, the feedback control circuit 325 including voltage comparison circuit 126 will result in a feedback control signal 128 to the primary side switching controller 114 that causes the switching controller 114 to reduce pulse skipping, and thereby increase power transfer to the auxiliary channel circuit 3118, as well as to the main channel circuit 3116. Thus, by imposing a load resistance 302 on the main channel output 123, the voltage comparison circuit 126 will operate the same as if the main channel load 124 were demanding more current, even though the state of the main channel load 124 may not have changed during this time period.

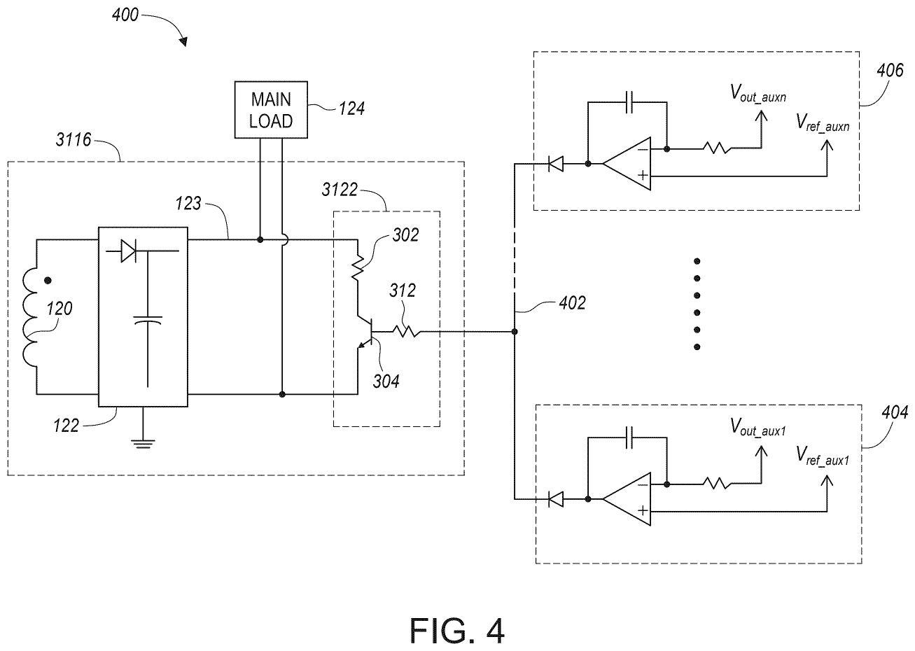

FIG. 4 shows a schematic diagram of load control in a power supply system 400 that includes multiple auxiliary channels when the main channel power circuit and auxiliary channel power circuits all share a common ground, in accordance with some embodiments of the present disclosure. For each auxiliary channel, there is an op amp circuit used to compare the output of the auxiliary channel to a selected reference voltage for that specific auxiliary channel circuit. The output diode (e.g. 314) for each of these comparison circuits is tied to a common load bus or line 402 and prevents interference between the comparison circuits for each auxiliary channel. For example, a first auxiliary channel 118 can have a first voltage comparison circuit 404. Each other auxiliary channel can have a similar voltage comparison circuit, thus an nth auxiliary channel circuit can have an nth voltage comparison circuit 406 that compares the output of the nth auxiliary channel, V_{out_auxn}, with a selected reference voltage, V_{ref_auxn}. Each of these voltage comparison circuits 404, 406 are substantially similar to voltage comparison circuit 3120 of FIG. 3. Thus, there can be n such voltage comparison circuits, one for each one of n auxiliary channels. The auxiliary channel experiencing the largest difference (negative) between its output level and its selected reference voltage will control the common line 402, meaning it will have the highest output to the transistor 304. Like the main channel load 124, each auxiliary load (e.g., 138) can be dynamic, changing based on whatever function in the circuity of the auxiliary load is active at a given time. As a result, when the main load 124 is not sufficient to cause the feedback to keep the switch control circuit active enough to provide the desired output at a given auxiliary channel, that auxiliary channel, through its respective voltage comparison circuit (e.g., 404, 406) can impose a load through load resistance 302 and load control transistor 304 on the main channel output to cause the switch controller to become more active, and not skip pulses. The base or gate of the load control transistor 304 acts as a control terminal to operate the load control transistor 304.

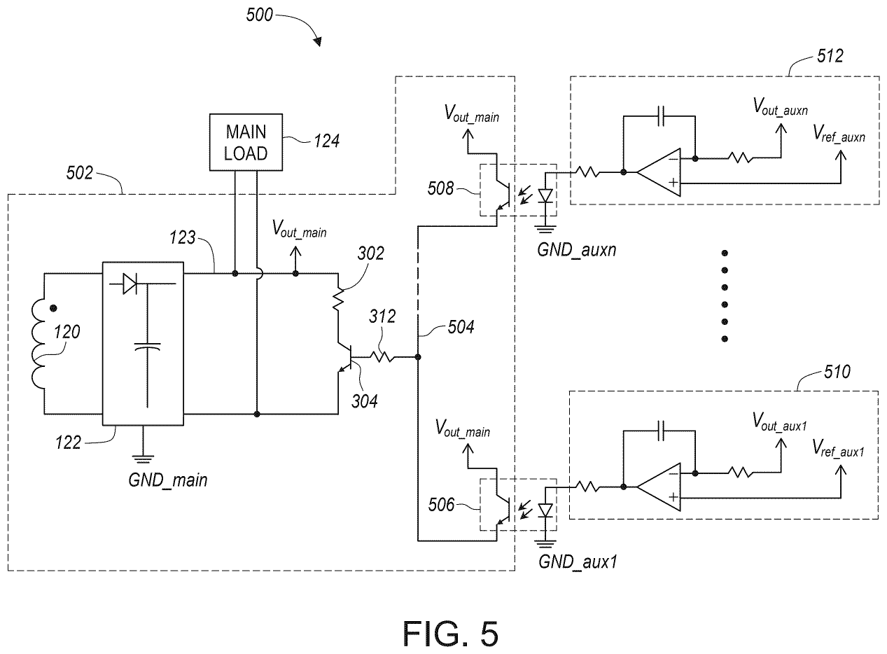

FIG. 5 shows a schematic diagram of load control in a power supply system 500 that includes multiple auxiliary channels when the main channel power circuit and auxiliary channel power circuits do not share a common ground, in accordance with some embodiments of the present disclosure. The main channel 502 uses a ground GND_main, while each auxiliary channel has its own ground, such as, for example, GND_aux1, and GND_auxn. As a result, it is not possible to directly tie the voltage comparison circuits 510, 512 to the load circuit of load resistance 302 and load control transistor 304, and there must be conductive isolation between the main channel and each of the auxiliary channels. To achieve this, the output of each voltage comparison circuit 510, 512 of each auxiliary channel is provided to the transmit side of a respective optocoupler 506, 508. The sensor side of the respective optocoupler 506, 508 is coupled to a common line 504 that is fed to load control transistor 304 (through resistance 312). Each of the voltage comparison circuits 510, 512 compare the output voltage at the respective auxiliary channel with a selected reference voltage. If the output voltage at a given auxiliary channel output drops below the selected reference voltage for that auxiliary channel, the voltage comparison circuit will conduct through the light element of its respective optocoupler to increase the load on the output of the main channel through loas resistance 302 and load control transistor 304.

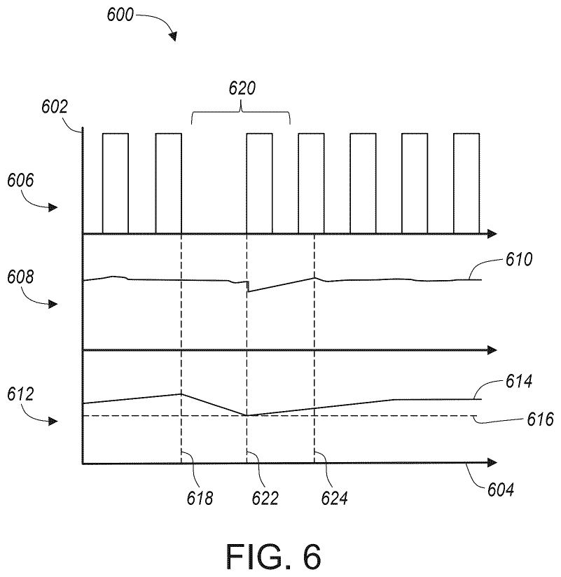

FIG. 6 is a graph chart illustrating operation 600 of a multi-channel power supply when the main load is at less than a nominal level, in accordance with some embodiments of the present disclosure. The vertical axis show relative magnitude of several signals, including the pulse output 606 of the switching control circuit to open and close the switch for flyback operation, the output 608 of the main channel voltage 610, and the output 612 of an auxiliary channel voltage 614. The horizontal axis 604 is time. At time 618, the main channel voltage 610 is relatively high, indicating a lower than average load. As a result, the switching controller commences pulse skipping for period 620. However, the auxiliary channel may have a higher than average load, and as a result, from time 618, the auxiliary channel voltage begins decreasing due to the lack of pulses through the transformer. By time 622 the auxiliary channel voltage 614 has dropped to a preselected threshold 616, which corresponds to the reference voltage value (e.g., 306), which causes the output of the voltage comparison circuit (e.g., 404, 510) to transition to a high output, which turns on the load transistor 304 and allows conduction through the load resistance 302, dropping the main channel voltage slightly after time 622. However, the main channel control feedback signal will then cause the switching controller to abandon the pulse skipping within period 620 and resume active switching, causing both the main and auxiliary voltage levels 610, 614 to increase. By time 624, the main load can increase, resulting in the switching controller continuing full switching with no pulse skipping, and keeping the auxiliary channel voltage 614 well above the threshold 616.

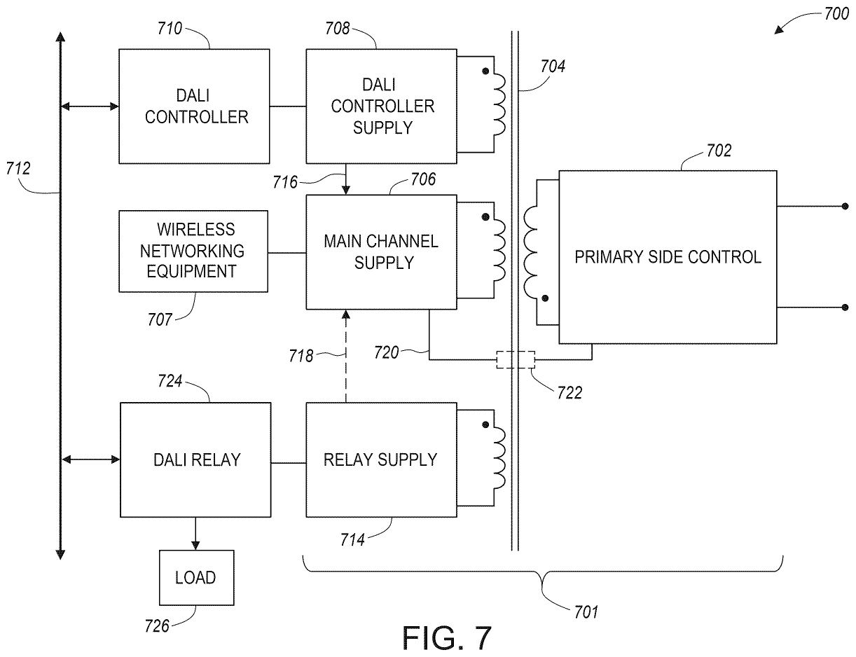

FIG. 7 shows a block schematic diagram of a lighting control system 700 using a multi-channel power supply 701 in accordance with some embodiments of the present disclosure. The lighting control system's power supply 701 includes a primary side control 702 that converts the input AC power to a DC voltage, which is switched using a flyback arrangement to transfer power through a transformer 704. A main channel 706 includes a regulated five-volt output, which is controlled by a feedback signal 720 through an isolated coupling 722 (e.g., an optocoupler) back to the primary side controller 702. The main channel 706 can provide power to, for example, a wireless networking component 707, such as a microcell controller.

A first auxiliary channel 708 can be a lighting controller channel that provides a power supply for a digital addressable lighting interface (DALI) controller 710, which is used for controlling lighting elements in a digital lighting system (meaning digitally controlled), in accordance with standard IEC 62386 of the International Electrotechnical Commission. The DALI controller 710 controls lighting elements via a lighting bus 712. A second auxiliary channel 714 can be relay channel that provides a power supply to power one or more DALI relays 724, which are responsive to signals on the DALI bus 712 to turn on or turn off various loads 726. The loads can be, for example, lighting elements such as lamps, window blinds (e.g. raise/lower), and other related equipment. Each of the auxiliary channels 708, 714 are able to provide a load control signal 716, 718, respectively to the load control in the main channel 706. The load control signals 716, 718 are provided by voltage comparison circuits in each of the auxiliary channels 708, 714. They can be directly coupled, as shown in FIG. 4, when the main channel 706 and auxiliary channels 708, 714 share a common ground, or they can be optically isolated signals as in FIG. 5.

Although the present disclosure illustrates and describes auto balanced multi-channel power supply, it is, nevertheless, not intended to be limited to the details shown because various modifications and structural changes may be made therein without departing from the spirit of the disclosure and while remaining within the scope and range of equivalents of the claims. Additionally, well-known elements of the disclosure will not be described in detail or will be omitted so as not to obscure the relevant details of the disclosure.

Features that are considered characteristic of the invention are set forth in the appended claims. As required, detailed embodiments of the small cell housing are disclosed herein; however, it is to be understood that the disclosed embodiments are merely exemplary, and the housing may be embodied in various forms. Therefore, specific structural and functional details disclosed herein are not to be interpreted as limiting, but merely as a basis for the claims and as a representative basis for teaching one of ordinary skill in the art to variously employ the claimed invention in appropriately detailed structures. Further, the terms and phrases used herein are not intended to be limiting; but rather, to provide an understandable description of the disclosure. While the specification concludes with claims defining the features of the invention, it is believed that the claimed invention will be better understood from a consideration of the following description in conjunction with the drawing figures, in which like reference numerals are carried forward. The figures of the drawings are not drawn to scale.

The terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. It should also be noted that the conjunctive terms, “and” and “or” are generally employed in the broadest sense to include “and/or” unless the content and context clearly dictates inclusivity or exclusivity as the case may be. In addition, the composition of “and” and “or” when recited herein as “and/or” is intended to encompass an embodiment that includes all of the associated items and one or more other alternative embodiments that include fewer than all of the associated items.

As used in this description, unless otherwise specified, azimuth or positional relationships indicated by terms such as “up”, “down”, “left”, “right”, “inside”, “outside”, “front”, “back”, “head”, “tail” and so on, are azimuth or positional relationships based on the drawings, which are only to facilitate description of the embodiments of the present disclosure and simplify the description, but not to indicate or imply that the devices or components must have a specific azimuth, or be constructed or operated in the specific azimuth, which thus cannot be understood as a limitation to the embodiments of the present disclosure. Furthermore, terms such as “first”, “second”, “third” and so on are only used for descriptive purposes and cannot be construed as indicating or implying relative importance.

As used in this description, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected, or may be indirectly connected via an intermediate medium. In this document, the term “longitudinal” should be understood to mean in a direction corresponding to an elongated direction of the device. Those skilled in the art can understand the specific meanings of the above-mentioned terms in the embodiments of the present disclosure according to the specific circumstances.

In the absence of any specific clarification related to its express use in a particular context, where the terms “substantial,” “about,” or “approximately” in any grammatical form are used as modifiers in the present disclosure and any appended claims (e.g., to modify a structure, a dimension, a measurement, or some other characteristic), it is understood that the characteristic may vary by up to 30 percent. For example, an electronic device may be described as being mounted “substantially vertical.” In such a case, a device that is mounted exactly vertical is mounted along a “Y” axis and a “X” axis that is normal (i.e., 90 degrees or at right angle) to a plane or line formed by a “Z” axis. Different from the exact precision of the term, “vertical,” the use of “substantially” or “about” to modify the characteristic permits a variance of the particular characteristic by up to 30 percent.

Reference throughout this specification to “one embodiment” or “an embodiment” or “some embodiments” and variations thereof mean that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The claims appended hereto are meant to cover all modifications and changes within the scope and spirit of the present disclosure.

What is claimed is:

1. A multi-channel power supply operable to supply electrical power to multiple electrical loads, the multi-channel power supply comprising:
a switching circuit that includes a switching controller and a transformer having a primary winding and a plurality of secondary windings, the switching circuit converting electrical power received at an input to the primary winding of the transformer into electrical powers at outputs of the secondary windings of the transformer responsive to a first control signal received by the switching controller;
a first channel circuit coupled to an output of a first secondary winding of the transformer, the first channel circuit including a feedback regulation circuit and a controlled load, the feedback regulation circuit providing the first control signal responsive to electrical loading applied to an output of the first channel circuit, the controlled load applying at least a minimum electrical load to the output of the first channel circuit responsive to receipt of a second control signal; and
a second channel circuit operably coupled to an output of a second secondary winding of the transformer, the second channel circuit outputting the second control signal when an electrical load is applied to an output of the second channel circuit.

2. The multi-channel power supply of claim 1, wherein the first channel circuit and the second channel circuit share a common ground and wherein the second channel circuit outputs the second control signal directly to the controlled load.

3. The multi-channel power supply of claim 1, wherein the first channel circuit and the second channel circuit do not share a common ground, the multi-channel power supply further comprising:
an optocoupler positioned between the first channel circuit and the second channel circuit, wherein the second channel circuit outputs the second control signal to the controlled load through the optocoupler.

4. The multi-channel power supply of claim 1, wherein the controlled load includes a load resistance in series with a load transistor, and wherein a control terminal of the load transistor is configured to receive the second control signal.

5. A multi-channel power supply operable to supply electrical power to multiple electrical loads, the multi-channel power supply comprising:
a switching circuit that includes a switching controller and a transformer having a primary winding and a plurality of secondary windings, the switching circuit converting first electrical power received at an input to the primary winding of the transformer into electrical powers at outputs of the secondary windings of the transformer responsive to a first control signal received by the switching controller;
a first channel circuit coupled to an output of a first secondary winding of the transformer, the first channel circuit including a feedback regulation circuit and a controlled load, the feedback regulation circuit providing the first control signal responsive to electrical loading applied to an output of the first channel circuit, the controlled load applying at least a minimum electrical load to the output of the first channel circuit responsive to receipt of at least one of a second control signal and a third control signal;
a second channel circuit operably coupled to an output of a second secondary winding of the transformer, the second channel circuit outputting the second control signal when a first auxiliary electrical load is applied to an output of the second channel circuit; and
a third channel circuit operably coupled to an output of a third secondary winding of the transformer, the third channel circuit outputting the third control signal when a second auxiliary electrical load is applied to an output of the third channel circuit.

6. The multi-channel power supply of claim 5, wherein the first channel circuit and the second channel circuit share a common ground and wherein the second channel circuit outputs the second control signal directly to the controlled load.

7. The multi-channel power supply of claim 5, wherein the first channel circuit and the second channel circuit do not share a common ground, the multi-channel power supply further comprising:
an optocoupler positioned between the first channel circuit and the second channel circuit, wherein the second channel circuit outputs the second control signal to the controlled load through the optocoupler.

8. The multi-channel power supply of claim 5, wherein the controlled load includes a load resistance in series with a load transistor, and wherein a control terminal of the load transistor is configured to receive at least one of the second control signal and the third control signal.

9. The multi-channel power supply of claim 5, wherein the first channel circuit and the third channel circuit share a common ground and wherein the third channel circuit outputs the third control signal directly to the controlled load.

10. The multi-channel power supply of claim 5, wherein the first channel circuit and the third channel circuit do not share a common ground, the multi-channel power supply further comprising:
an optocoupler positioned between the first channel circuit and the third channel circuit, wherein the third channel circuit outputs the third control signal to the controlled load through the optocoupler.

11. The multi-channel power supply of claim 5, wherein the first channel circuit, the second channel circuit, and the third channel circuit share a common ground, wherein the second channel circuit outputs the second control signal directly to the controlled load, and wherein the third channel circuit outputs the third control signal directly to the controlled load.

12. The multi-channel power supply of claim 5, wherein the first channel circuit, the second channel circuit, and the third channel circuit do not share a common ground, the multi-channel power supply further comprising:
a first optocoupler positioned between the first channel circuit and the second channel circuit, wherein the second channel circuit outputs the second control signal to the controlled load through the first optocoupler; and
a second optocoupler positioned between the first channel circuit and the third channel circuit, wherein the third channel circuit outputs the third control signal to the controlled load through the second optocoupler.

13. A multi-channel power supply operable to supply electrical power to multiple electrical loads, the multi-channel power supply comprising:
a primary side switching controller;
a first channel circuit including an output, a first load, and a regulator feedback circuit, the regulator feedback circuit providing a feedback regulation signal to the primary side switching controller responsive to a total load on the output of the first channel circuit;
a controllable load coupled in parallel with the first load and responsive to a load control signal, wherein the first load and the controllable load together are the total load on the output of the first channel circuit; and
a second channel circuit having an output that is independent of the output of the first channel circuit and including a voltage comparison circuit that compares an output voltage thereof with a preselected reference voltage and provides the load control signal to the controllable load when the output voltage is lower than the preselected reference voltage.

14. The multi-channel power supply of claim 13, further comprising:
a third channel circuit that includes a second voltage comparison circuit that compares an output voltage thereof with a second preselected reference voltage and provides the load control signal to the controllable load when the output voltage of the third channel circuit is lower than the second preselected reference voltage.

15. The multi-channel power supply of claim 13, wherein the first channel circuit and the second channel circuit share a common ground, and the load control signal is provided directly to the controllable load.

16. The multi-channel power supply of claim 13, wherein the first channel circuit and the second channel circuit do not share a common ground, and the load control signal is provided to the controllable load through an optocoupler.

17. The multi-channel power supply of claim 13, wherein the controllable load includes a load resistance in series with a load transistor, and wherein a control terminal of the load transistor is configured to receive the load control signal to switch the load resistance in parallel with the first load.
